(19) United States
(12) Patent Application Publication
(10) Pub. No.: US 2006/0026438 A1
(43) Pub. Date: Feb. 2, 2006

(54) Anonymous aliases for on-line communications

(75) Inventors: Pablo M. Stern, San Francisco, CA (US); Aditya P. Bansod, Sunnyvale, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/901,526

(22) Filed: Jul. 29, 2004

(51) Int. Cl. H04K 1/00; G06F 17/24; H04L 9/32; G06F 17/00

(52) U.S. Cl. 713/184; 726/2; 715/752; 715/507

(57) ABSTRACT

Generation of anonymous aliases for on-line communications is described. In response to a user input to generate an anonymous alias, the anonymous alias is generated and associated with an established alias corresponding to the user, and an identification field in an on-line document is then determined and the anonymous alias is displayed in the identification field of the on-line document.

### TECHNICAL FIELD

This invention relates to anonymous user identification for on-line communications and, in particular, to anonymous aliases.

### BACKGROUND

Electronic mail, also commonly referred to as “email” or “e-mail”, is increasingly utilized as an electronic form of communication via the Internet. A user can send an email as a text message with optional attachments from a client device using the traditional ampersand formulation. For example, an email message can be addressed to an intended recipient John Smith at a company having the domain name “xyzcompany.com” as “johnsmith@xyzcompany.com”. An email service typically communicates the email message through a TCP/IP network (e.g., the Internet) to a server assigned the domain name “xyzcompany.com”. The recipient, John Smith, can then access the email message by downloading it from the server to his own client device. The email message will identify the user as the sender of the email and, similarly, the user may receive a return email message from the recipient at the user's email address.

When the user initiates a request to access a Web site from the client device, the Web site may require the user to fill-in an on-line document and provide identification, such as a username and/or an email address, and a password to establish an account or to register before information available at the Web site can be accessed. As users increasingly provide or submit their email addresses via email messages and through on-line forms and documents, the email addresses are often obtained by unintended recipients who then “spam” the many users with unsolicited email messages.

Spam is unsolicited email often sent to email distribution lists that include a large number of users' email addresses. Spam is similar to telemarketing and is the electronic equivalent of “junk mail” used to advertise products and services, request charitable donations, or to broadcast some political or social commentary. Spamming is the practice of sending an unsolicited email message to large numbers of email addresses indiscriminately. Spam emails are often unwanted by the many recipients and are considered a waste of not only the recipients' time, but network bandwidth. Accordingly, users that communicate via email and provide identification through other on-line documents need a way to provide an email address as a form of user identification, yet maintain their privacy and anonymity from unwanted solicitation.

Some conventional email systems provide a feature that is accessible through a Web browser to create a disposable email address which is associated with an established email address of a user. The disposable email address can be utilized to mask the identity of the user when replying to a received email message, or when sending a new email message. Additionally, email messages that are received and addressed to the disposable email address can be routed for storage in an email folder associated with the disposable email address.

### SUMMARY

Generation of anonymous aliases for on-line communications is described herein.

In an implementation of anonymous aliases for on-line communications, an input is received from a user to generate an anonymous alias. In response to the user input, the anonymous alias is generated and associated with an established alias corresponding to the user. Additionally, an identification field in an on-line document, such as a Web-based form or an email message, is determined and the anonymous alias is displayed in the identification field of the on-line document.

### BRIEF DESCRIPTION OF THE DRAWINGS

The same numbers are used throughout the drawings to reference like features and components.

FIG. 1 illustrates various components of an exemplary computing system in which embodiments of anonymous aliases can be implemented.

FIG. 2 illustrates an exemplary Web browser that displays an on-line document in which a user can submit an anonymous alias to identify the user.

FIG. 3 illustrates an exemplary Web browser that displays a new email message in which a user can submit an anonymous alias to identify the user as the sender of the email message.

FIG. 4 is a flow diagram that illustrates an exemplary method for an embodiment of anonymous aliases.

FIG. 5 is a flow diagram that illustrates an exemplary method for an embodiment of anonymous aliases.

### DETAILED DESCRIPTION

Anonymous aliases provide that users who communicate via email and submit an email address as user identification through on-line documents can maintain their privacy and anonymity from unwanted solicitation. A user can create a new email address as an anonymous alias which can be used to identify the user as the sender of an email message. The anonymous alias can also be used as identification to establish an account or to register with a Web site such that information available at the Web site can be accessed.

An anonymous alias can be created and associated with a user account, and can then be disclosed without compromising an established email address of a user. If the user begins receiving spam email messages addressed to the anonymous alias, the user can simply delete the anonymous alias which effectively stops delivery of the unsolicited email messages. Optionally, any email messages already received to the anonymous alias before it is deleted can be saved and may not be deleted along with the anonymous alias. Alternatively, the user can rename the anonymous alias which also stops delivery of any unsolicited email messages, yet maintains folder routing information associated with the anonymous alias.

While aspects of the described systems and methods for anonymous aliases can be implemented in any number of different computing systems, environments, and/or configurations, embodiments of anonymous aliases are described in the context of the following exemplary system architecture.

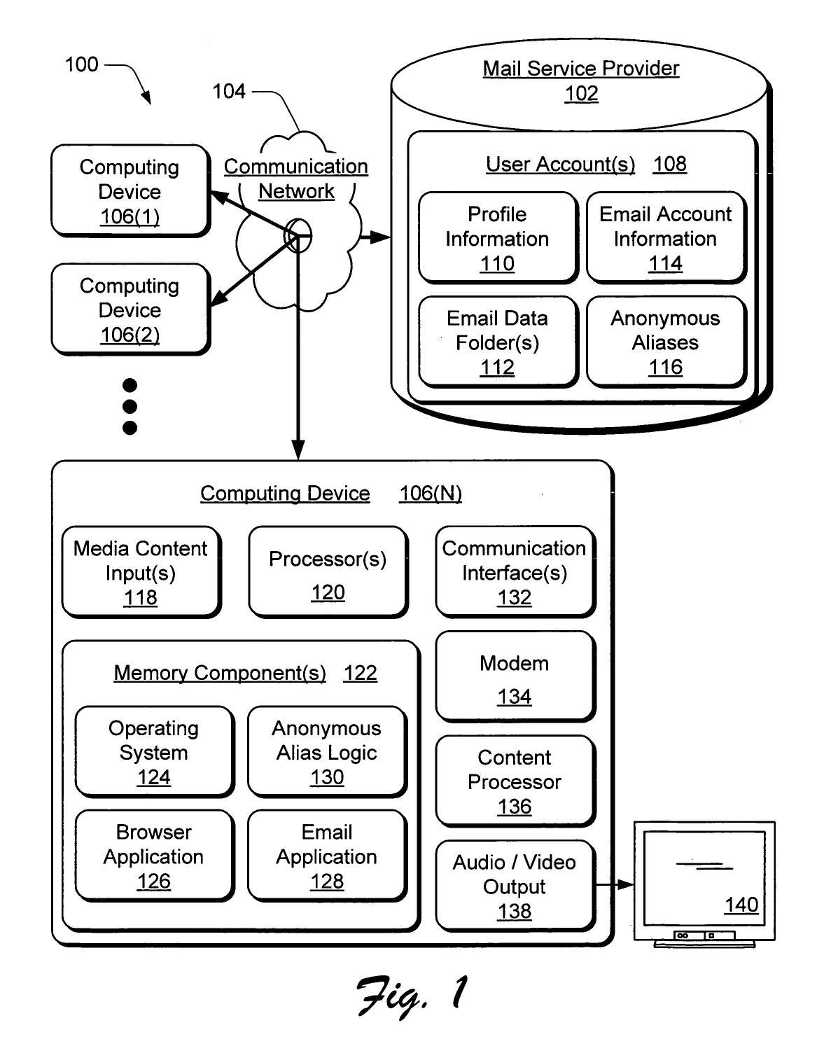

FIG. 1 illustrates various components of an exemplary computing system 100 in which embodiments of anonymous aliases can be implemented. Computing system 100 includes a mail service provider 102, a communication network 104, and one or more computing devices 106(1-N).

The communication network 104 communicatively couples the mail service provider 102 and the computing devices 106 to each other and/or to the Internet for communication within the World Wide Web (“Web”). The communication network 104 can be implemented as any data communication medium, Internet protocol (IP) connection, application program interface (API), or communication system having any protocol and/or messaging format. For example, the communication network 104 can be implemented as a local area network (LAN), a wide area network (WAN), a public network such as the Internet, and/or any combination thereof. Although not shown, communication between devices in the computing system 100 can also be facilitated via a cable network, radio frequency signal, over-air broadcast, satellite transmission, and the like.

Mail service provider 102 is an example of a network-based electronic mail service that can be accessed by computing devices 106 through the communication network 104 to facilitate the exchange of email messages. The mail service provider 102 maintains multiple user accounts 108 and manages the exchange and distribution of email messages between the computing devices 106. The mail service provider 102 maintains such items as profile information 110, email data folder(s) 112, email account information 114, and anonymous aliases 116 all associated with a particular user account 108. The email data folder(s) 112 form a “mailbox” for a particular user corresponding to a user account 108 and each folder 112 receives and maintains email messages that are addressed to the particular user. Email data maintained in each folder 112 can include incoming and/or outgoing email messages for and from a particular user associated with a user account 108.

The email account information 114 includes a primary, or established, email address of a user corresponding to the user account 108. For example, a particular user may have an email address of “user@msp102.com” (e.g., mail service provider 102) which, in this example, has a basename of “user”. The anonymous aliases 116 are separate email addresses that are created and associated with an established email address of a user. The anonymous aliases 116 are also distinct from the established email address of the user and do not have a basename corresponding to the established email address. For example, the user may have any number of anonymous aliases, such as an “anyname˜friends@msp102.com” alias, an “anyname˜work@msp102.com” alias, and an “anyname˜purchase@msp102.com” alias. The user can provide the “anyname˜friends” alias for communication with friends, provide the “anyname˜work” alias to correspond with co-workers on work-related issues, and provide the “anyname˜purchase” alias when filling in an on-line document or form to register or establish an account with a Web site.

Each anonymous alias has a basename, “anyname˜”, that is distinct from the established email address of the user, and includes an alias modifier, such as “friends”, “work”, and “purchase”. The anonymous alias distinction from the established email address ensures that an unintended recipient who generates unsolicited email messages cannot decipher the established account name from an anonymous alias. In this example, the “˜” character separates the basename and the alias modifier and is merely exemplary. Any character or identifier can be used to precede the alias modifier when an anonymous alias is generated. In this example, the “˜” character is implementation specific, compatible with current standards, and does not conflict with email addresses that may be currently in use.

Not only are the email aliases anonymous such that a recipient cannot directly target back to an email sender with unsolicited communications, the email aliases are “purposed” in that a user can select alias modifiers that are descriptive, useful, and meaningful to the user. As another example, a user may create a “anyname˜bills@msp102.com” alias that the user provides to on-line bill paying services.

The email data folders 112 can include a “friends” folder corresponding to the “anyname˜friends@msp102.com” alias, a “work” folder corresponding to the “anyname˜work@msp102.com” alias, and a “purchase” folder corresponding to the “anyname˜purchase@msp102.com” alias. When an email message is received and addressed to the user at the “anyname˜purchase@msp102.com” alias, for example, the email message is stored in the “purchase” folder and the user can then access the email message by downloading it from the mail service provider 102 to the computing device 106.

It is not uncommon for one company to sell users' email addresses to other companies and organizations which then become part of an email distribution list for unsolicited spam communications. If the “anyname˜purchase@msp102.com” alias becomes a target for such unsolicited communications, the user can simply delete the alias which effectively stops delivery of the unwanted emails. Further, the established email address, “user@msp102.com”, is not compromised and the privacy and anonymity of the user is maintained. Alternatively, the user can rename the anonymous alias which also stops delivery of any unsolicited email messages, yet maintains any folder routing information associated with the anonymous alias. The mail service provider 102 can be implemented to maintain a list of Web sites (e.g., as email account information 114) associated with a particular anonymous alias such that the user can determine which Web sites are or will be affected when the anonymous alias is deleted or renamed.

A computing device 106 can be implemented in any number of embodiments with numerous other general purpose or special purpose computing system environments or configurations. Examples of well known computing systems, environments, and/or configurations that may be implemented in the exemplary computing system 100 include, but are not limited to, personal computers, server computers, Web browsers, hand-held or laptop devices, multiprocessor systems, microprocessor-based systems, set-top boxes, programmable consumer electronics, network PCs, minicomputers, mainframe computers, a digital video recorder (DVR) and playback system, gaming consoles, distributed computing environments that include any of the above systems or devices, and the like.

The computing device 106 includes one or more media content inputs 118 which may include Internet Protocol (IP) inputs over which streams of media content are received via an IP-based network (e.g., communication network 104). The media content inputs 118 may also include tuners that can be tuned to various frequencies or channels to receive television signals when computing device 106 is embodied as a set-top box or as a digital video recorder, for example. The computing device 106 also includes one or more processors 120 (e.g., any of microprocessors, controllers, and the like) which process various instructions to control the operation of computing device 106 and to communicate with other electronic and computing devices.

The computing device 106 can be implemented with one or more memory components 122, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like. The memory components 122 provide data storage mechanisms to store various information and/or data such as received media content, software applications, and any other types of information and data related to operational aspects of computing device 106.

An operating system 124, a browser application 126, and an email application 128 can be maintained with non-volatile memory components 122 and executed on processor(s) 120. The browser application 126 provides a user interface through which a user can interact with and browse the Web. The email application 128 facilitates email communication and provides a user interface through which a user can interact with the mail service provider 102 and user account 108 information associated with the particular user.

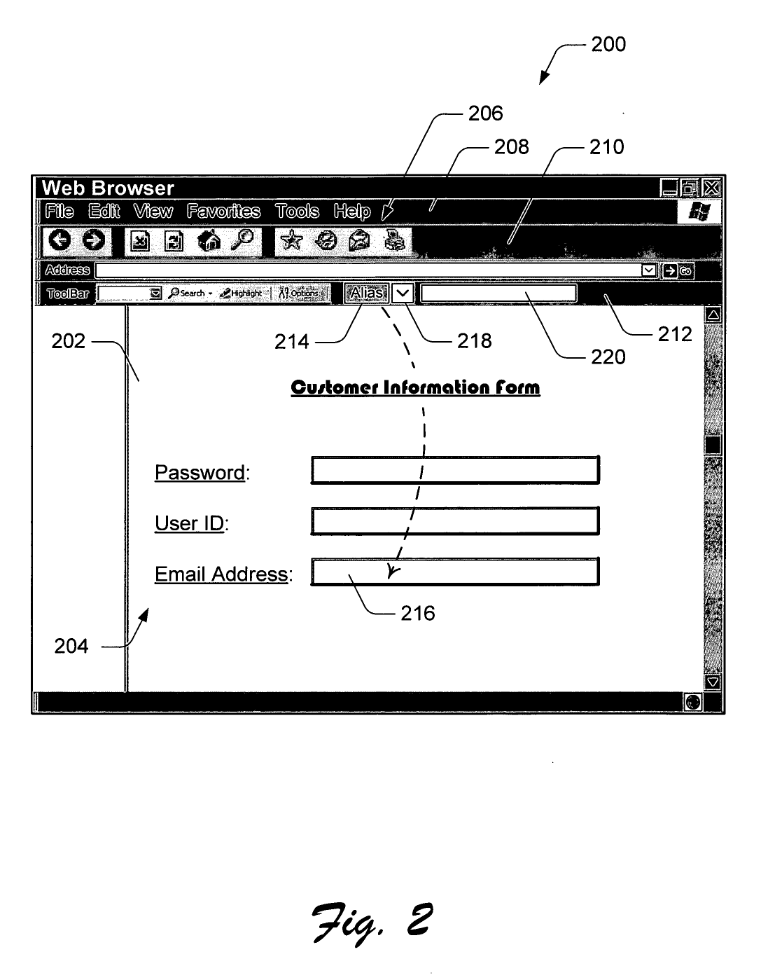

In this example, anonymous alias logic 130 is also maintained with non-volatile memory components 122 as a software application that can be executed on processor(s) 120 to implement embodiments of anonymous aliases. As described below with reference to FIGS. 2-5, the anonymous alias logic 130 can generate an anonymous alias for a user when initiated to do so, determine an alias identification field in an on-line document (e.g., a Web-based form or email message), and initiate a display of the anonymous alias in the alias identification field.

Although the anonymous alias logic 130 is illustrated and described as a single application, the anonymous alias logic 130 can be implemented as several component applications distributed to each perform one or more functions in the exemplary computing system 100. Alternatively, the anonymous alias logic 130 may be implemented as a component of the browser application 126 or as a component of the email application 128. Further, the anonymous alias logic 130 may be implemented on a device other than the computing device 106, where the other device may also be configured for communication with computing device 106 in the computing system 100. For example, the anonymous alias logic 130, or components of the anonymous alias logic 130, can be implemented at the mail service provider 102, at computing device 106(N) as shown, at computing device 106(1), or within any combination thereof.

As used herein, the term “logic” (e.g., the anonymous alias logic 130) can also refer to hardware, firmware, software, or any combination thereof that may be implemented to perform the logical operations associated with the embodiments of anonymous aliases. Logic may also include any supporting circuitry utilized to complete a given task including supportive non-logical operations.

The computing device 106 further includes communication interface(s) 132 and a modem 134. The communication interface(s) 132 can be implemented as any one or more of a serial and/or parallel interface, a wireless interface, any type of network interface, and as any other type of communication interface. A wireless interface enables computing device 106 to receive control input commands and other information from an input device, such as from a remote control device or from another infrared (IR), 802.11, Bluetooth, or similar RF input device.

A network interface provides a connection between computing device 106 and the communication network 104 by which the other electronic and computing devices (e.g., mail service provider 102) coupled to communication network 104 communicates information, data, and email messages to computing device 106. Similarly, a serial and/or parallel interface provides a data communication path directly between computing device 106 and the other electronic or computing devices. Modem 134 facilitates computing device 106 communication with the other electronic and computing devices via a conventional telephone line, a DSL connection, cable, and/or other type of connection. Although not shown, computing device 106 may also include user input devices such as a keyboard, mouse, pointing device, and/or other mechanisms to interact with, and to input information to computing device 106.

Computing device 106 also includes a content processor 136 which can include a video decoder and/or additional processors to receive, process, and decode media content and display data. Computing device 106 also includes an audio and/or video output 138 that provides audio and video to an audio rendering and/or display device 140, or to other devices that process, display, and/or otherwise render audio, video, and display data. Video signals and audio signals can be communicated from computing device 106 to display device 140 via an RF (radio frequency) link, S-video link, composite video link, component video link, analog audio connection, or other similar communication links.

Although shown separately, some of the components of computing device 106 may be implemented in an application specific integrated circuit (ASIC). Additionally, a system bus (not shown) typically connects the various components within computing device 106. A system bus can be implemented as one or more of any of several types of bus structures, including a memory bus or memory controller, a peripheral bus, an accelerated graphics port, or a local bus using any of a variety of bus architectures.

The mail service provider 102 may also be implemented as a computing device with any number and combination of differing components as described above with reference to a computing device 106. For example, the mail service provider 102 can include processor(s) 120, memory component(s) 122, and communication interface(s) 132.

FIG. 2 illustrates a Web browser 200 through which an on-line document 202 is displayed. The browser application 126 of the computing device 106 (FIG. 1) generates the Web browser 200 for display on the display device 140 through which a user can interact with and browse the Web. In this example, the on-line document 202 is a form generated at a Web site that requires a user to provide identification 204, such as a password, user ID, and an email address to establish an account or to register before information available at the Web site can be accessed.

The Web browser 200 includes any number of selectable controls 206 which may be included in a context menu 208 and/or a menu bar 210 within the Web browser 200. The Web browser 200 also includes a toolbar 212 that is installed as a component of the browser application 126. Supplemental or third party toolbars (e.g., toolbar 212) provide that a user can search the Internet from any Web page and may include optionally customizable functions for quick access to a search engine and to user-selected Web sites. Additionally, a supplemental toolbar may include a “pop-up guard” to help prevent most pop-up advertisements from being displayed while a user browses the Web. Although not shown, anonymous alias functionality may also be implemented as a deskbar included in a user interface display, or may be integrated as a component of an operating system user interface.

The toolbar 212 includes a user-selectable control 214, labeled “Alias” in this example, by which a user can initiate an embodiment of anonymous aliases. When a user selects the alias control 214 to initiate the anonymous alias logic 130 (FIG. 1) to generate an anonymous alias for the user, the anonymous alias logic 130 can optionally initiate user authentication prior to creating an anonymous alias to ensure that the anonymous alias is only being created by a user that owns an established email account.

In this example, the user can select the alias control 214 which initiates the anonymous alias logic 130 (FIG. 1) to generate an anonymous alias for the user, determine an alias identification field 216 in the on-line document 202, and initiate a display of the anonymous alias in the alias identification field 216. For example, a user may fill-in the customer information form (e.g., the on-line document 202) with the identification information 204, but may prefer not to disclose the established email address “user˜msp102.com” of the user. The anonymous alias logic 130 can generate the “anyname˜purchase@msp102.com” alias which is associated with and displayed in the identification field 216 such that the privacy and anonymity of the user is not compromised.

The toolbar 212 also includes a drop-down user-selectable control 218 which is associated with the anonymous alias control 214. The drop-down control 218, when selected, displays a list of previously generated anonymous aliases from which a user can select an anonymous alias to include in the alias identification field 216 of the on-line document 202. Alternatively, or in addition, the anonymous alias logic 130 can be implemented to auto-populate the alias identification field 216 when a user navigates back to a previously visited Web page, such as on-line document 202, if the user previously generated or selected an anonymous alias for the Web page.

The toolbar 212 can also include an anonymous alias field 220 in which a suggested anonymous alias us provided for user selection when the user navigates to an on-line document. The anonymous alias logic 130 can be implemented to determine the alias identification field 216 in the on-line document 202 and provide a suggested anonymous alias in the anonymous alias field 220 of the toolbar 212. The suggested anonymous alias can be the last anonymous alias created, an anonymous alias associated with a particular Web page or Web site, or an anonymous alias based on any other implementation factor.

The anonymous alias logic 130 can randomly generate an anonymous alias when initiated to do so, or a user can be prompted to provide input for the anonymous alias. The anonymous alias logic 130 can be configured with preference settings to generate or request a basename and/or an alias modifier that are combined to form an anonymous alias. For example, a user having an established email address of “user@msp102.com” may select or create a new basename of “anyname˜” and an alias modifier “purchase” which are combined to generate the anonymous alias “anyname˜purchase@msp102.com”. When a new basename is created, an alias modifier can be auto-generated and/or a user can selectively create an alias modifier.

The anonymous alias logic 130 can also be implemented to generate an anonymous alias that is associated with a property of a particular on-line document. For example, an anonymous alias can be generated that includes the <title> tag in the HTML (Hyper Text Markup Language) of the on-line document 202 (e.g., for a Web page). The <title> tag can be parsed and a pseudo-random alias can be auto-generated, such as “anyname˜customerinfo@msp102” for the on-line document 202. Alternatively, or in addition, the anonymous alias logic 130 can generate an anonymous alias from the metadata in the on-line document 202 to auto-generate an alias modifier that is context-relevant to the on-line document.

The anonymous alias logic 130 compares a newly created or user-provided basename to the user accounts 108 maintained by the mail service provider 102 to determine whether the new basename is distinctive (e.g., unique and not duplicative of another basename). Further, when an anonymous alias is generated, the anonymous alias is associated with a particular user account 108, and optionally, a new email data folder 112 corresponding to the new anonymous alias is created to maintain emails that may be addressed to the user at the anonymous alias. A new email data folder 112 can be created for a user-provided anonymous alias that corresponds to the name of the user-provided alias, such as an email folder entitled “purchases” that corresponds to the anonymous alias “anyname˜purchase@msp 102.com”.

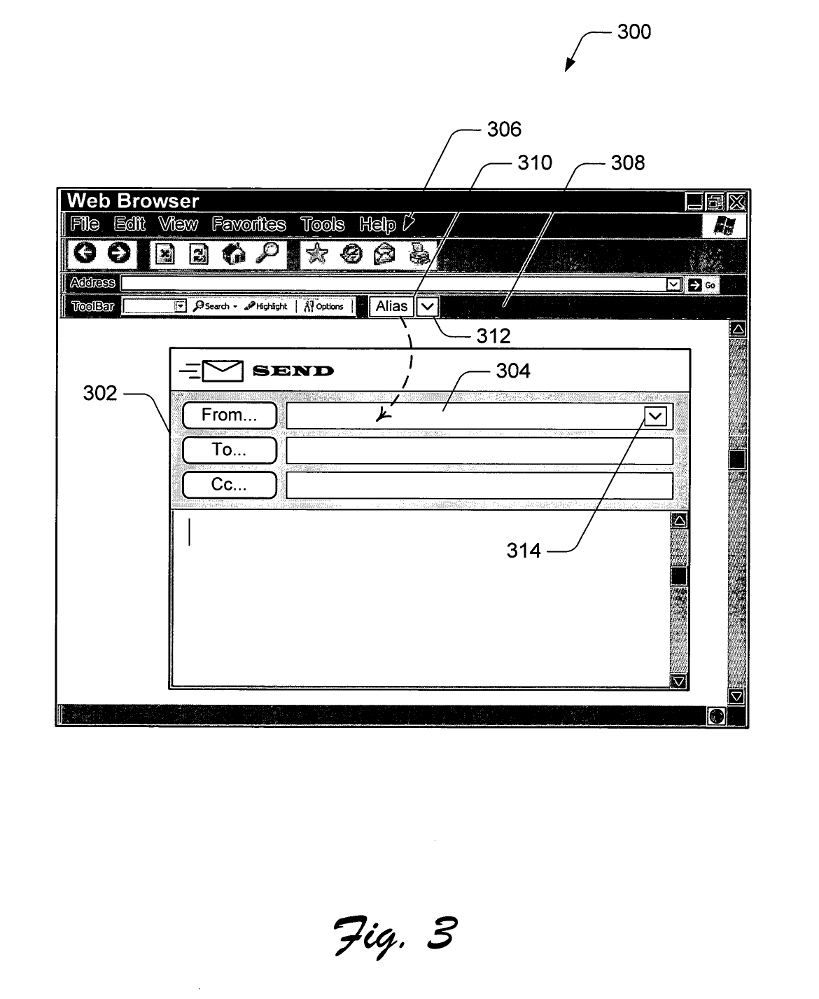

FIG. 3 illustrates a Web browser 300 through which a new email message 302 is displayed and can be composed by a user. The user can submit an anonymous alias as an email address in an email alias identification field 304 to identify the user as the sender of the email message 302. The browser application 126 (FIG. 1) generates the Web browser 300 for display on the display device 140, and the email application 128 generates the email message 302 (e.g., an on-line document) for display within the Web browser 300.

As described with reference to Web browser 200 (FIG. 2), the Web browser 300 includes any number of selectable controls 306 which may be included in a context menu and/or a menu bar within the Web browser 300. The Web browser 300 also includes a toolbar 308 that is installed as a component of the browser application 126. The toolbar 308 includes a user-selectable control 310, labeled “Alias” in this example, by which a user can initiate an embodiment of anonymous aliases. In this example, the user can select the alias control 310 which initiates the anonymous alias logic 130 (FIG. 1) to generate an anonymous alias for the user, and display the anonymous alias within the email alias identification field 304.

The toolbar 308 also includes a drop-down user-selectable control 312 which is associated with the anonymous alias control 310. The drop-down control 312, when selected, displays a list of previously generated anonymous aliases from which a user can select an anonymous alias to include in the email alias identification field 304 of the email message 302. Alternatively, or in addition, the “From” address line (e.g., the email alias identification field 304) of the email message 302 can include a drop-down user-selectable control 314 which, when selected, displays a list of previously generated anonymous aliases from which the user can select an anonymous alias to include in the email. Additionally, an anonymous alias selected for association with the email message 302 may be set as a default alias for the particular email message. The anonymous alias logic 130 can also include integrated send/reply functionality such that when a user replies to an email message, the email alias identification field 304 is automatically filled-in with the anonymous alias that the received email message was directed to.

Although not shown, the anonymous alias functionality is not limited to a toolbar integrated into a Web browser. Alternatively, the anonymous alias functionality may also be implemented, or integrated, as a component of an on-line document or email system user interface in association with any on-line document experience. For example, an email-based client device can support the anonymous alias functionality to provide the selection of an anonymous alias when composing a new email message.

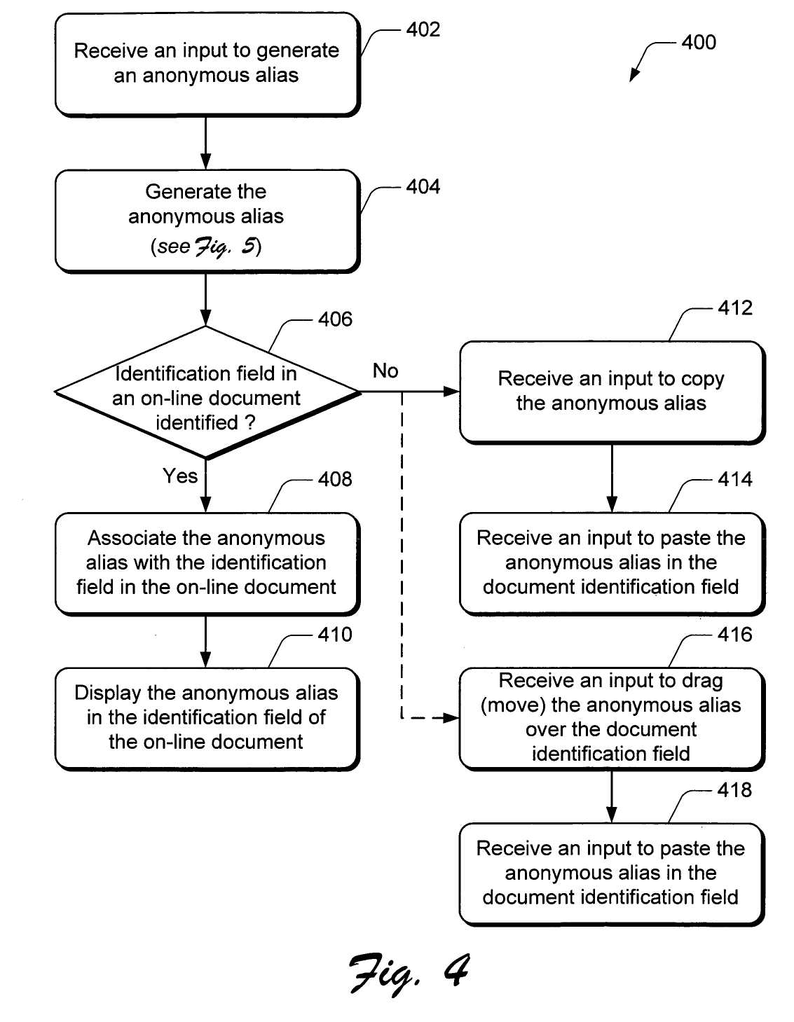

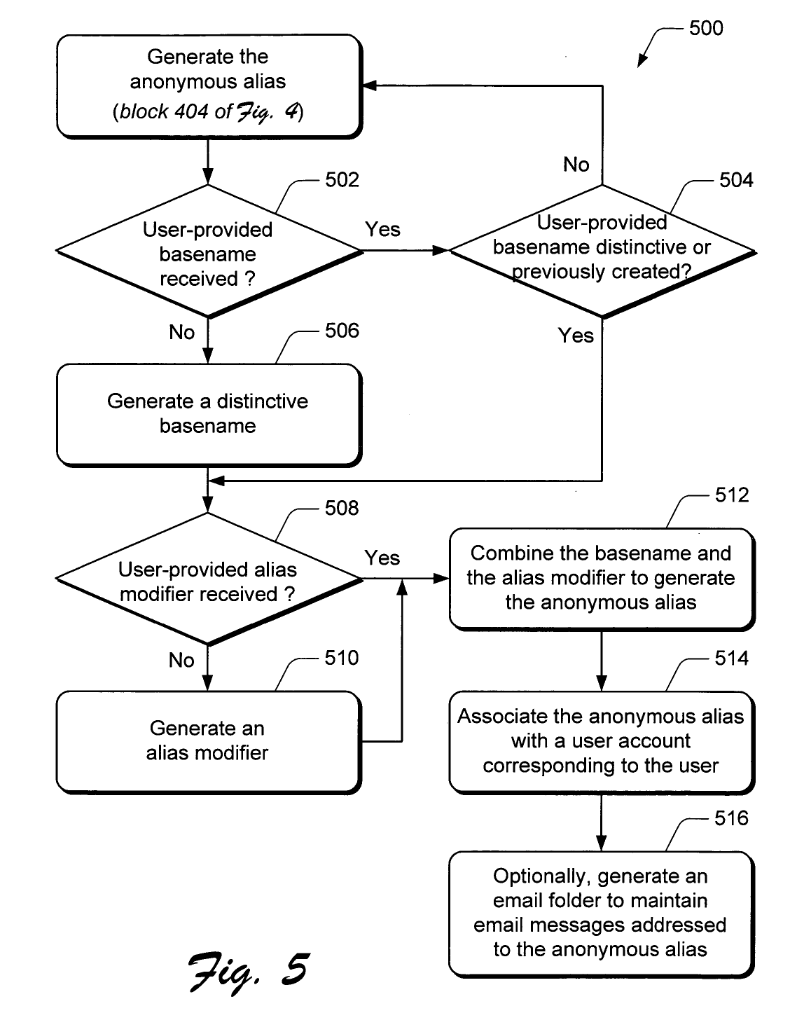

Methods for anonymous aliases, such as exemplary methods 400 and 500 described with reference to FIGS. 4 and 5 respectively, may be described in the general context of computer executable instructions. Generally, computer executable instructions include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

FIG. 4 illustrates an exemplary method 400 for anonymous aliases. The order in which the method is described is not intended to be construed as a limitation, and any number of the described method blocks can be combined in any order to implement the method. Furthermore, the method can be implemented in any suitable hardware, software, firmware, or combination thereof.

At block 402, an input to generate an anonymous alias is received. For example, a user can initiate the generation of an anonymous alias by selecting the user-selectable control 214 on the Web browser toolbar 212 (FIG. 2). At block 404, the anonymous alias is generated. For example, the anonymous alias logic 130 (FIG. 1) generates the anonymous alias as described below with reference to FIG. 5. When an anonymous alias is generated, the anonymous alias logic 130 (FIG. 1) can optionally initiate user authentication prior to creating the anonymous alias to ensure that the anonymous alias is only being created by a user that owns an established email account.

At block 406, a determination is made as to whether an identification field in an on-line document has been identified, or determined. For example, the anonymous alias logic 130 can determine whether on-line document 202 includes the email identification field 216 (FIG. 2), or whether the email message 302 includes the email alias identification field 304 (FIG. 3).

If the identification field in the on-line document has been identified (i.e., “yes” from block 406), then the anonymous alias is associated with the identification field in the on-line document at block 408. At block 410, the anonymous alias is then displayed in the identification field of the on-line document. If an identification field in an on-line document can not be identified, or determined (i.e., “no” from block 406), then inputs to copy and paste the anonymous alias in the on-line document identification field are received at blocks 412 and 414, respectively. Alternatively, inputs to drag and drop (e.g., move and paste) the anonymous alias in the on-line document identification field are received at blocks 416 and 418, respectively.

FIG. 5 illustrates an exemplary method 500 for anonymous aliases. The order in which the method is described is not intended to be construed as a limitation, and any number of the described method blocks can be combined in any order to implement the method. Furthermore, the method can be implemented in any suitable hardware, software, firmware, or combination thereof.

At block 502, a determination is made as to whether a user-provided basename is received. For example, a user may be prompted to provide a basename, or the user may select one from a list of current basenames. So as not to reveal an established email address, such as “user@msp102.com”, a user may input a basename of “anyname”, for example, to create a new account having an email address of “anyname@msp102.com”.

If the user has provided a basename (i.e., “yes” from block 502), then a determination is made as to whether the user-provided basename is distinctive or has been previously created at block 504. If a user newly creates the user-provided basename, the anonymous alias logic 130 (FIG. 1) compares the user-provided basename to the user accounts 108 maintained at the mail service provider 102 to determine whether the user-provided basename is distinctive (i.e., unique and not duplicative of another basename). A previously created, user-selected basename can be re-used and would have been determined to be distinctive when created. If the user-provided basename is not distinctive (i.e., “no” from block 504), then the method 500 begins again to generate the anonymous alias.

If the user has not provided a basename (i.e., “no” from block 502), then a distinctive basename is generated at block 506. For example, the anonymous alias logic 130 randomly generates a distinctive basename. After the distinctive basename has been generated at block 506, or if the user-provided basename is distinctive (i.e., “yes” from block 504), then a determination is made as to whether a user-provided alias modifier is received at block 508. For example, a user may be prompted to provide an alias modifier, such as “purchase” to utilize when an on-line document or form requires an email address to register or establish an account with a Web site.

If the user has not provided an alias modifier (i.e., “no” from block 508), then an alias modifier is generated at block 510. For example, the anonymous alias logic 130 randomly generates an alias modifier. The anonymous alias logic 130 can generate an anonymous alias that is associated with a property of a particular on-line document, such as an anonymous alias generated from metadata in an on-line document that is context-relevant to the on-line document. After the alias modifier has been generated at block 510, or if the user has provided an alias modifier (i.e., “yes” from block 508), then the basename and the alias modifier are combined to generate the anonymous alias at block 512.

At block 514, the anonymous alias is associated with a user account corresponding to the user that initiates generating the anonymous alias. At block 516, an email folder is optionally generated to maintain email messages addressed to the user at the anonymous alias. For example, the anonymous alias logic 130 generates the anonymous alias from a combination of the basename and alias modifier, associates the anonymous alias with a user account, and optionally, generates the email folder associated with the anonymous alias.

Although embodiments of anonymous aliases have been described in language specific to structural features and/or methods, it is to be understood that the subject of the appended claims is not necessarily limited to the specific features or methods described. Rather, the specific features and methods are disclosed as exemplary implementations of anonymous aliases.

1. An anonymous alias system, comprising:
a selectable control configured to initiate the generation of an anonymous alias when selected; and
alias logic configured to generate the anonymous alias and initiate a display of the anonymous alias in an identification field of an on-line document.

2. An anonymous alias system as recited in claim 1, wherein the selectable control is displayed on a Web browser toolbar.

3. An anonymous alias system as recited in claim 1, wherein the selectable control is displayed in an email system user interface.

4. An anonymous alias system as recited in claim 1, wherein the selectable control is displayed in a user interface deskbar.

5. An anonymous alias system as recited in claim 1, wherein the on-line document is a Web-based form displayed in a Web browser, and wherein the alias logic is further configured to initiate a display of the anonymous alias in the identification field of the Web-based form.

6. An anonymous alias system as recited in claim 1, wherein the on-line document is an email displayed in an email system user interface, and wherein the alias logic is further configured to initiate a display of the anonymous alias in the identification field of the email.

7. An anonymous alias system as recited in claim 1, wherein the on-line document is an email displayed in an email system user interface, and wherein the alias logic is further configured to generate the anonymous alias as an email address and initiate a display of the email address in the identification field of the email.

8. An anonymous alias system as recited in claim 1, wherein the alias logic is further configured to associate the anonymous alias with an established alias of a user.

9. An anonymous alias system as recited in claim 1, wherein the alias logic is further configured to generate a basename and an alias modifier which are combined to form the anonymous alias.

10. An anonymous alias system as recited in claim 1, wherein the alias logic is further configured to:
determine whether a user-provided basename is distinctive; and
generate the anonymous alias from a combination of the user-provided basename and a user-provided alias modifier.

11. An anonymous alias system as recited in claim 1, wherein the alias logic is further configured to:
determine whether a user-provided basename is distinctive; and
generate the anonymous alias from a combination of the user-provided basename and a randomly generated alias modifier.

12. An anonymous alias system as recited in claim 1, wherein the alias logic is further configured to:
receive a user-selected basename as an input selected from a list of established basenames; and
generate the anonymous alias from a combination of the user-selected basename and a user-provided alias modifier.

13. An anonymous alias system as recited in claim 1, wherein the alias logic is further configured to:
receive a user-selected basename as an input selected from a list of established basenames; and
generate the anonymous alias from a combination of the user-selected basename and a randomly generated alias modifier.

14. An anonymous alias system as recited in claim 1, wherein the alias logic is further configured to generate an email folder corresponding to the anonymous alias to maintain email messages addressed to the anonymous alias.

15. An email service provider comprising the anonymous alias system as recited in claim 1, wherein the on-line document is an email, and wherein the alias logic is further configured to:
generate the anonymous alias as an email address; and
initiate a display of the email address in the identification field in the email.

16. An email service provider comprising the anonymous alias system as recited in claim 1, wherein the on-line document is an email, and wherein the alias logic is further configured to:
generate the anonymous alias as an email address;
initiate a display of the email address in the identification field in the email; and
generate an email folder corresponding to the email address to maintain email messages addressed to the anonymous alias.

17. An email service provider comprising the anonymous alias system as recited in claim 1, wherein the on-line document is an email, and wherein the alias logic an email client application configured to:
generate the anonymous alias as an email address;
initiate a display of the email address in the identification field in the email;
generate an email folder corresponding to the email address to maintain email messages addressed to the anonymous alias; and
receive the email messages addressed to the anonymous alias and route the email messages to the email folder.

18. A Web browser comprising a selectable control that, when selected, is configured to initiate generation of an anonymous alias that is auto-filled into a user identification field of an on-line document displayed through the Web browser.

19. A Web browser as recited in claim 18, wherein the selectable control is integrated into a toolbar within the Web browser.

20. A Web browser as recited in claim 18, wherein a basename and an alias modifier are generated and combined to generate the anonymous alias.

21. A Web browser as recited in claim 18, wherein the on-line document is a Web-based form, and wherein the anonymous alias is generated as an email address that is auto-filled into the user identification field in the Web-based form.

22. A Web browser as recited in claim 18, wherein the on-line document is an email, and wherein the anonymous alias is generated as an email address that is auto-filled into the user identification field in the email.

23. A user interface comprising a selectable control that, when selected, is configured to initiate generation of an anonymous alias that is auto-filled into a user identification field of an on-line document displayed on the user interface.

24. A user interface toolbar as recited in claim 23, wherein the selectable control is a component of an operating system user interface.

25. A user interface toolbar as recited in claim 23, wherein the selectable control is a component of an email system user interface.

26. A user interface toolbar as recited in claim 23, the anonymous alias is generated context-relevant of the on-line document.

27. A user interface toolbar as recited in claim 23, wherein a basename and an alias modifier are generated and combined to generate the anonymous alias.

28. A user interface toolbar as recited in claim 23, wherein the on-line document is an email, and wherein the anonymous alias is generated as an email address that is auto-filled into the user identification field in the email.

29. A user interface toolbar as recited in claim 23, wherein the on-line document is a Web-based form, and wherein the anonymous alias is generated as an email address that is auto-filled into the user identification field in the Web-based form.

30. In response to receiving an input to generate an anonymous alias, a method comprising:
generating the anonymous alias for an on-line communication;
determining an identification field in an on-line document; and
displaying the anonymous alias in the identification field in the on-line document.

31. A method as recited in claim 30, further comprising displaying the anonymous alias in the identification field of the on-line document which is a Web-based form displayed through a Web browser.

32. A method as recited in claim 30, further comprising displaying the anonymous alias in the identification field of the on-line document which is an email displayed in an email system user interface.

33. A method as recited in claim 30, further comprising associating the anonymous alias with an established alias of a user that initiates the input to generate the anonymous alias.

34. A method as recited in claim 30, wherein generating the anonymous alias includes generating a basename and an alias modifier which are combined to form the anonymous alias.

35. A method as recited in claim 30, wherein generating the anonymous alias includes:
generating a basename that is distinctive;
generating an alias modifier; and
generating the anonymous alias from a combination of the basename and the alias modifier.

36. A method as recited in claim 30, wherein generating the anonymous alias includes:
receiving a user-provided basename;
determining whether the user-provided basename is distinctive;
receiving a user-provided alias modifier; and
generating the anonymous alias from a combination of the user-provided basename and the user-provided alias modifier.

37. A method as recited in claim 30, wherein generating the anonymous alias includes:
receiving a user-provided basename;
determining whether the user-provided basename is distinctive;
randomly-generating an alias modifier; and
generating the anonymous alias from a combination of the user-provided basename and the randomly-generated alias modifier.

38. A method as recited in claim 30, further comprising:
displaying the anonymous alias on a user interface;
copying the anonymous alias in response to a user-selectable copy input; and
pasting the anonymous alias in the identification field of the on-line document in response to a user-selectable paste input.

39. A method as recited in claim 30, further comprising:
displaying the anonymous alias on a user interface;
moving the anonymous alias in response to a user-selectable drag input; and
pasting the anonymous alias in the identification field of the on-line document in response to a user-selectable drop input.

40. A method as recited in claim 30, wherein:
the anonymous alias is generated as an email address;
the on-line document is an email; and
the email address is displayed in the identification field in the email.

41. A method as recited in claim 30, further comprising generating an email folder corresponding to the anonymous alias to maintain email messages addressed to the anonymous alias.

42. A method as recited in claim 30, further comprising:
generating an email folder corresponding to the anonymous alias to maintain email messages addressed to the anonymous alias; and
routing the email messages addressed to the anonymous alias to the email folder when received.

43. One or more computer readable media comprising computer executable instructions that, when executed, direct an anonymous alias system to perform the method as recited in claim 30.

44. One or more computer readable media comprising computer executable instructions that, when executed, direct an anonymous alias system to:
generate an anonymous alias in response to an input from a user;
associate the anonymous alias with an established alias of the user;
determine an identification field in an on-line document; and
associate the anonymous alias for display in the identification field of the on-line document.

45. One or more computer-readable media as recited in claim 44, further comprising computer executable instructions that, when executed, direct the anonymous alias system to generate a basename and an alias modifier which are combined to form the anonymous alias.

46. One or more computer-readable media as recited in claim 44, further comprising computer executable instructions that, when executed, direct the anonymous alias system to:
determine whether a user-provided basename is distinctive; and
generate the anonymous alias from a combination of the user-provided basename and a user-provided alias modifier.

47. One or more computer-readable media as recited in claim 44, further comprising computer executable instructions that, when executed, direct the anonymous alias system to:
determine whether a user-provided basename is distinctive; and
generate the anonymous alias from a combination of the user-provided basename and a randomly generated alias modifier.

48. One or more computer-readable media as recited in claim 44, further comprising computer executable instructions that, when executed, direct the anonymous alias system to:
receive a user-selected basename as an input selected from a list of established basenames; and
generate the anonymous alias from a combination of the user-selected basename and a user-provided alias modifier.

49. One or more computer-readable media as recited in claim 44, further comprising computer executable instructions that, when executed, direct the anonymous alias system to:
receive a user-selected basename as an input selected from a list of established basenames; and
generate the anonymous alias from a combination of the user-selected basename and a randomly generated alias modifier.

50. One or more computer-readable media as recited in claim 44, further comprising computer executable instructions that, when executed, direct the anonymous alias system to generate an email folder corresponding to the anonymous alias to maintain email messages addressed to the anonymous alias.

51. One or more computer-readable media as recited in claim 44, further comprising computer executable instructions that, when executed, direct the anonymous alias system to:
generate the anonymous alias as an email address; and
generate an email folder corresponding to the anonymous alias to maintain email messages addressed to the anonymous alias.

52. An anonymous alias system, comprising:
means for initiating the generation of an anonymous alias;
means for generating the anonymous alias in response to an input from a user;
means for associating the anonymous alias with an established alias of the user; and
means for associating the anonymous alias with an identification field in an on-line document to display the anonymous alias in the identification field.

53. An anonymous alias system as recited in claim 52, further comprising means for generating a basename and an alias modifier which are combined to form the anonymous alias.

54. An anonymous alias system as recited in claim 52, further comprising:
means for determining whether a user-provided basename is distinctive; and
means for generating the anonymous alias from a combination of the user-provided basename and a user-provided alias modifier.

55. An anonymous alias system as recited in claim 52, further comprising:
means for randomly generating a distinctive basename;
means for randomly generating an alias modifier; and
means for generating the anonymous alias from a combination of the randomly generated distinctive basename and the randomly generated alias modifier.

56. An anonymous alias system as recited in claim 52, further comprising means for generating an email folder corresponding to the anonymous alias to maintain email messages addressed to the anonymous alias.
